(19) United States
(12) Patent Application Publication
(10) Pub. No.: US 2008/0016705 A1
(43) Pub. Date: Jan. 24, 2008

(54) Portable handheld work apparatus

(76) Inventors: Kai-Ulrich Machens, Stuttgart (DE); Philipp Neumann, Stuttgart (DE); Thomas Hilt, Winnenden (DE); Gunter Mayer, Untereisesheim (DE); Adalbert Vielberth, Titting (DE)

Correspondence Address: WALTER OTTESEN, PO BOX 4026, GAITHERSBURG, MD, 20885-4026, US

(21) Appl. No.: 11/826,550

(22) Filed: Jul. 17, 2007

(30) Foreign Application Priority Data
Jul. 19, 2006 (DE) 10 2006 033 344.6

(51) Int. Cl. B23D 57/02

(52) U.S. Cl. 30/383

(57) ABSTRACT

A portable handheld work apparatus has a motor housing (2) wherein a drive motor (18) is mounted. The drive motor (18) drives a work tool. The work tool is operatively connected via a drive shaft (8) to the drive motor (18). A coupling device (65, 66, 67) is mounted in the operative connection between the drive shaft (8) and the work tool in order to avoid a transmission of vibrations of the work tool to the drive shaft (8). The coupling device (65, 66, 67) permits a limited movement of the work tool relative to the drive shaft (8).

### CROSS REFERENCE TO RELATED APPLICATION

This application claims priority of German patent application no. 10 2006 033 344.6, filed Jul. 19, 2006, the entire content of which is incorporated herein by reference.

### FIELD OF THE INVENTION

The invention relates to a portable handheld work apparatus having a motor housing wherein a drive motor is mounted. The drive motor drives a work tool and the work tool is operatively connected to the drive motor via a drive shaft.

### BACKGROUND OF THE INVENTION

U.S. Pat. No. 5,926,961 discloses a work apparatus in the form of an overhead branchcutter. The work apparatus has a drive motor which drives a work tool in the form of a saw chain via a drive shaft configured with multiple parts.

Work tool and drive shaft of a portable handheld work apparatus can form a system capable of vibration. If the work tool is, for example, a saw chain or a rotating cutting knife, the occurring cutting forces cause vibrations of the work tool because of the fluctuating loads. The cutting forces occur, for example, at the individual cutting links of the saw chain or the blades of the knife. This vibration or oscillation excitation of the work tool is transmitted to the drive shaft. The vibration-capable system made up of work tool and drive shaft can be excited to natural oscillations. This leads to increased vibrations, increased noise and an increased load on the operator during operation.

U.S. Pat. No. 6,502,315 discloses mounting a damping element on the centrifugal clutch of a motor-driven chainsaw. This damping element reduces the transmission of vibrations between the drive motor and the work tool.

### SUMMARY OF THE INVENTION

It is an object of the invention to provide a portable handheld work apparatus of the kind described above wherein a vibration excitation of the drive shaft by the work tool is prevented or reduced.

The portable handheld work apparatus of the invention includes: a motor housing; a work tool; a drive shaft; connecting means for operatively connecting the work tool to the drive shaft; a drive motor mounted in the housing for driving the work tool via the drive shaft and the connecting means; and, the connecting means including a coupling device disposed between the drive shaft and the work tool for permitting a limited movement of the work tool relative to the drive shaft.

The transmission of vibration to the drive shaft occurring during operation on the work tool is hindered by the coupling device mounted in operative connection between drive shaft and work tool. In this way, no natural vibration of the vibration-capable system of drive shaft and work tool can form. The vibrations and the running noise are reduced. The coupling device permits only a limited movement of the work tool relative to the drive shaft.

The drive shaft is guided in a guide tube especially over at least a portion of its length. The guide tube is attached with the-first end to the motor housing and with the opposite-lying second end to a component on which the work tool is mounted. During operation, vibrations or oscillations can increasingly develop in the oscillating system of work tool and drive shaft especially when long drive shafts are guided in a guide tube. The component on which the work tool is mounted is especially a gear assembly housing. The drive shaft is advantageously operatively connected to the work tool via a gear assembly mounted in the gear assembly housing. The gear assembly is part of the vibration-capable system of work tool and drive shaft and can be excited to oscillations by the loads of the work tool occurring during operation.

Advantageously, the coupling device is mounted between the drive shaft and the gear assembly. The work tool and the gear assembly are mounted spatially close to each other. In this system, no significant vibrations can form during operation. It can, however, be provided that the coupling device is mounted between the gear assembly and the work tool. In this case, not only the drive shaft is vibration decoupled from the work tool but also the gear assembly. The solution provided by the invention is especially provided in work apparatus wherein the length of the guide tube is more than half a meter. For short guide tubes or short drive shafts, the vibrations which form are comparatively small during operation.

A centrifugal clutch is mounted between the drive motor and the drive shaft. In this way, the drive motor is only then coupled to the drive shaft when a pregiven rpm is reached. This facilitates the starting of the internal combustion engine. Vibration damping elements can be provided on the centrifugal clutch in the operative connection between drive motor and drive shaft in order to reduce the transmission of vibrations of the drive motor to the drive shaft.

It is practical that the coupling device has a drive element at the motor end and an output element at the work tool end. A simple configuration of the coupling device results when drive element and output element, which each have at least one pawl, establish the operative connection between the drive element and the output element. Advantageously, at least one coupling element is mounted in the operative connection between the drive element and the output element. Via the coupling element, the characteristics of the transmission of forces from the drive element to the output element and from the output element to the drive element can be influenced. According to a feature of the invention, the coupling element is movable by an angle relative to one of the elements of drive element and output element. The magnitude of the angle determines the movability between drive element and output element. The other of the elements is advantageously so connected to the coupling device that no relative movement is possible between the other element and the coupling device.

In order to influence the formation of natural vibrations, it is provided that the coupling element has damping characteristics and/or spring characteristics. Several different coupling elements with different characteristics can be provided. Especially, the coupling device has other spring and/or damping characteristics in the operating direction from drive motor to the work tool than in the work direction from work tool to the drive motor. This can be advantageously achieved in that, in one operating direction, the coupling takes place via a first coupling element and in the opposite direction via a second coupling element which has different spring and/or damping characteristics. It is practical that the coupling device is a free-running unit. For a free-running unit, an independent movement of the work tool and the drive motor is possible at least in one region of the relative movement. In this region of the relative movement, drive motor and work tool are completely decoupled from each other. Advantageously, the work tool is a saw chain and the work apparatus is an overhead branchcutter. The drive motor is especially an internal combustion engine. However, an electric motor can also be provided as a drive motor.

### BRIEF DESCRIPTION OF THE DRAWINGS

The invention will now be described with reference to the drawings wherein:

FIG. 1 is a schematic perspective view of an overhead branchcutter;

FIG. 2 is an exploded perspective view of a gear assembly housing of an overhead branchcutter;

FIG. 3 is a section view taken through the gear assembly housing of FIG. 2 at the elevation of the free-running unit;

FIG. 4 is a section view through an embodiment of a gear assembly housing at the elevation of the free-running unit;

FIG. 5 is an exploded perspective view of the gear assembly housing of FIG. 4; and,

FIG. 6 shows, in section, an embodiment of a coupling device.

### DESCRIPTION OF THE PREFERRED EMBODIMENTS OF THE INVENTION

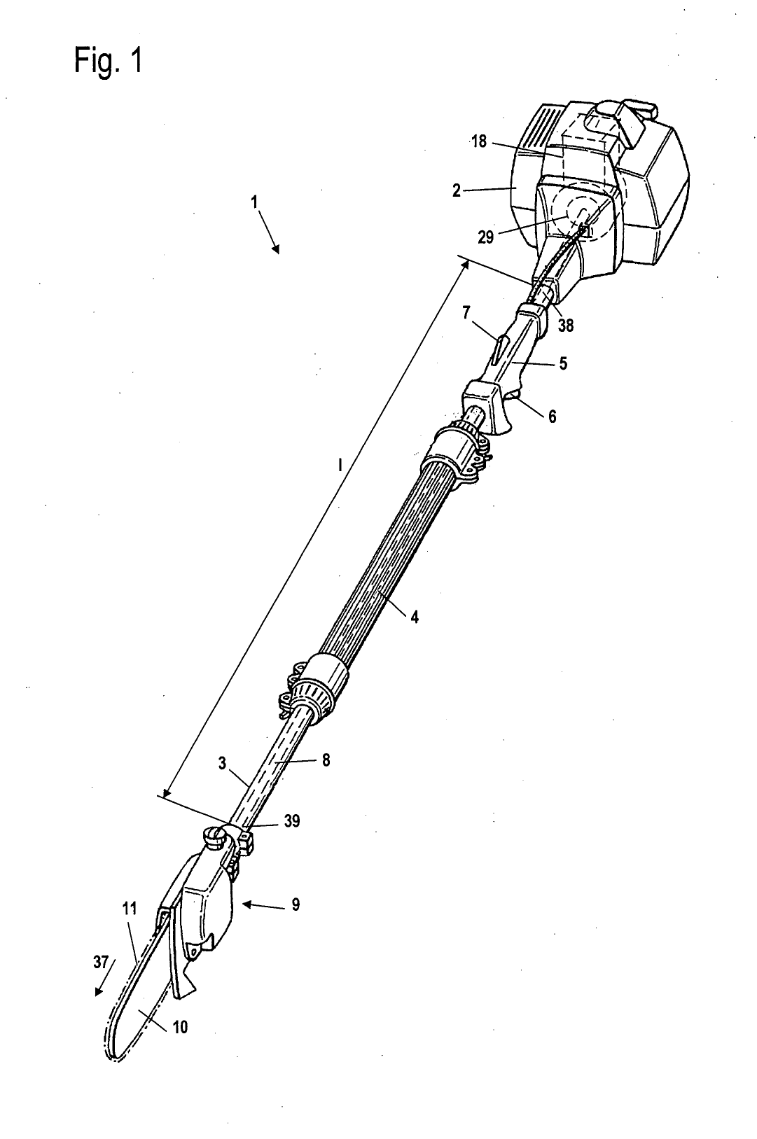

The overhead branchcutter 1 shown in FIG. 1 includes a motor housing 2 in which a drive motor 18 is mounted. The drive motor 18 is an internal combustion engine and is especially a single cylinder two-stroke engine. The crankshaft (not shown) of the drive motor 18 is connected to a drive shaft 8 via a centrifugal clutch 29. The drive shaft 8 extends from the centrifugal clutch 29 up to a gear assembly housing 9. A guide bar 10 is mounted on the gear assembly housing 9 and a saw chain 11 is arranged on the guide bar. The saw chain is driven along the periphery of the guide bar in the drive direction 37. The drive shaft 8 drives the saw chain 11 via a gear assembly not shown in FIG. 1.

The motor housing 2 is connected via a guide tube 3 to the gear assembly housing 9. A first end 38 of the guide tube 3 is fixedly attached to the motor housing 2 and an opposite-lying second end 39 is attached to the gear assembly housing 9. The guide tube 3 has a telescopic section 4. Accordingly, the guide tube 3 is configured to have multiple parts. The drive shaft 8 is also of multiple parts so that the length L of the guide tube 3 and therefore the distance between the motor housing 2 and the gear assembly housing 9 can be changed. The distance between the motor housing 2 and the gear assembly housing 9 and therefore the length L of the guide tube 3 is considerably greater than a half meter when the telescopic section 4 is pushed together. The length L of the guide tube 3 can, for example, amount to two to four meters.

A handle 5 for guiding the overhead branchcutter 1 is mounted on the guide tube 3 next to the end 38 thereof. A throttle lever 6 and a throttle lever lock 7 for operating the drive motor 18 are mounted on the handle 5.

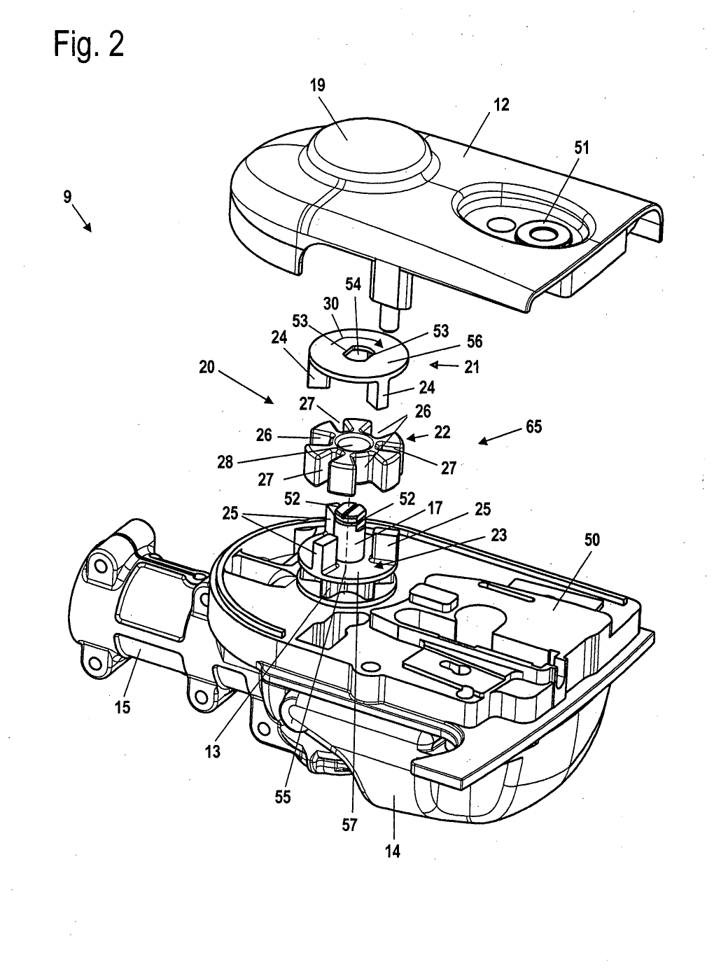

FIG. 2 shows a first embodiment of a gear assembly housing 9 wherein the drive motor 18 and the saw chain 11 are operatively connected via a coupling device 65. The coupling device 65 is configured as a free-running unit 20. The gear assembly housing 9 has a receptacle 15 for the guide tube 3. With the receptacle 15, the gear assembly housing 9 can be fixedly clamped to the guide tube 3. A support surface 50 is formed on the gear assembly housing 9 on which the guide bar 10 is to be mounted. The guide bar 10 is clamped between the support surface 50 and a sprocket wheel cover 12. For this purpose, a nut 51 is provided on the outer side of the sprocket wheel cover 12. The nut 51 can be threadably engaged onto a threaded bolt (not shown) of the gear assembly housing 9. The sprocket wheel cover 12 has furthermore a receptacle 19 for the free-running unit 20 and a drive sprocket wheel 13. The sprocket wheel cover 12 is arcuately-shaped outwardly in the region of the receptacle 19.

The drive sprocket wheel 13 drives the saw chain 11 in the drive direction 37 shown in FIG. 1. For this purpose, the drive sprocket wheel 13 is driven in a rotational direction 30. The drive of the drive sprocket wheel 13 takes place via the drive shaft 8 and the gear assembly not shown in FIG. 2. The gear assembly drives an intermediate shaft 17 which extends through the drive sprocket wheel 13. The intermediate shaft 17 has flats 52. The free-running unit 20 has a drive element 21 which is operatively connected to the drive shaft 8 and an output element 23 which is connected to the drive sprocket wheel 13 so as to rotate therewith. The drive element 21 has an opening 54 which is narrowed on two opposite-lying sides 53 which coact with the flats 52 formed on the intermediate shaft 17. The intermediate shaft 17 is connected to the drive element 21 so as to rotate therewith and rotatingly drives the drive element 21 about the rotational axis 55. The drive element 21 has pawls 24 which project in the direction toward the drive sprocket wheel 13. Three pawls 24 are arranged equidistant from each other on the drive element 21 and are mounted at a radial distance to the rotational axis 55 of the intermediate shaft 17. The drive element 21 has a planar base plate on which pawls 24 are formed.

The output element 23 has pawls 25 which project away from the drive sprocket wheel 13 and toward the drive element 21. Three pawls 25 are provided at a radial spacing to the rotational axis 55. The pawls 25 are at equal spacings to each other in the peripheral direction. The output element 23 has a planar base plate 57 on which the pawls 25 are formed.

The pawls 24 and 25 lie between the base plates 56 and 57 in one plane. A coupling element 22 is mounted between the base plates 56 and 57 and is operatively connected between the drive element 21 and the output element 23. The coupling element 22 has a center bore 28 through which the intermediate shaft 17 projects. The coupling element 22 has radially extending slots 26 for the pawls 24 and radially extending slots 27 for the pawls 25. The slots 26 and 27 extend radially inwardly from the periphery of the coupling element 22. The slots can, however, also be closed at the periphery.

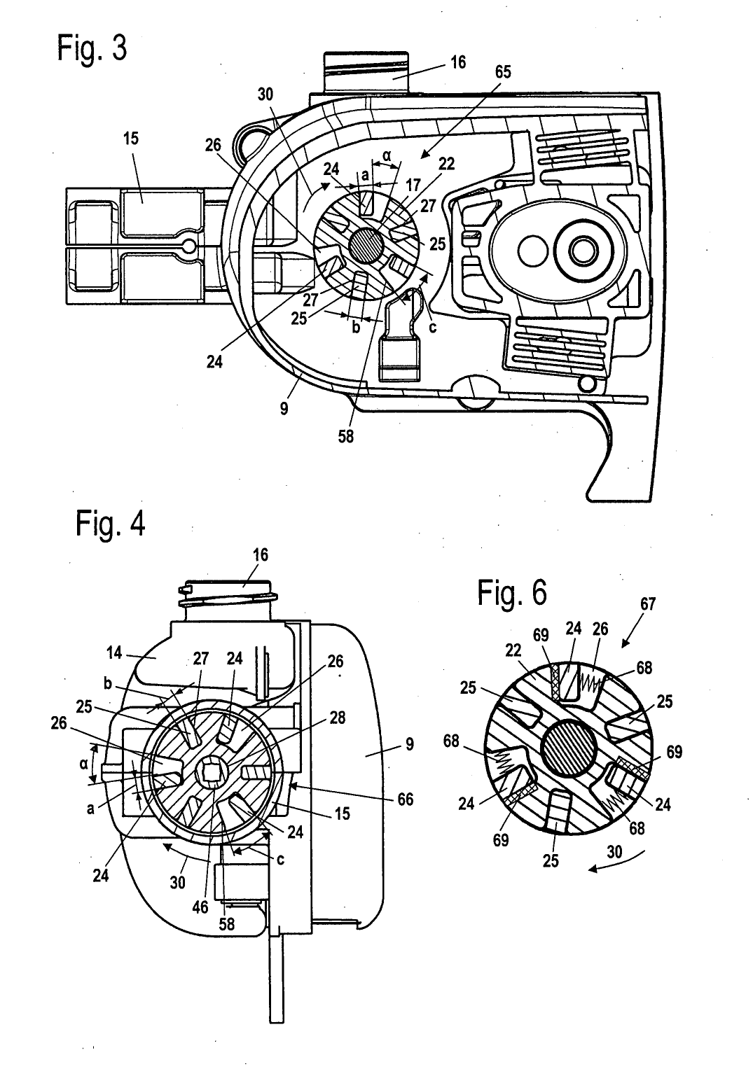

As shown in FIG. 2, the gear assembly housing 9 has a lubricating oil tank 14 for lubricating the saw chain 11. As shown in FIG. 3, the lubricating oil tank 14 has a fill stub 16. The section in FIG. 3 shows the arrangement of the pawls 24 and 25 in the coupling device 22. The width of the slots 27 corresponds to the width (b) of the pawls 25. The width (b) is measured in the peripheral direction to the coupling device 22 and to the rotational axis 55 (FIG. 2). The pawls 24 have a width (a) measured in the peripheral direction and this width (a) corresponds to the width (b) of the pawls 25. The width (c) of the slots 26 is greater than the width (a) of the pawls 24.

When the drive element 21 with the pawls 24 moves in the rotational direction 30, then the pawls 24 must first pass through the angle (α) between each pawl 24 and the corresponding stop 58 which is formed by the side wall of the slot 26 before a torque is transmitted to the output element 23. The spacing of the angle (α) between the pawls 24 and the corresponding stops 58 thereby makes possible a limited movement of the saw chain 11 relative to the drive shaft 8. The saw chain 11 is braked when in engagement with a workpiece. The free-running unit 20 permits a braking of the saw chain 11 relative to the drive shaft 8 until the pawls 24 lie against the stops 58. Then, the saw chain 11 is accelerated. If the output element 23 is faster than the drive element 21, for example, because a tooth of the saw chain becomes disengaged, then the drive shaft 8 is at first not braked by the saw chain 11; instead, the coupling device 22 is moved relative to the pawls 24 until the pawls 24 lie against the side wall of the slots 26 lying opposite the stop 58 with the pawls 24 being in the position shown in FIG. 3. In this way, the movement of the saw chain 11 is not directly transmitted to the drive shaft 8. The limited decoupling of the movement leads to the situation that a formation of natural vibrations is prevented in the vibration-capable system made up of drive shaft 8, gear assembly and saw chain 11. The angle (α) can lie between 5° and 60°. Advantageously, the angle (α) lies in the range of 10° to 30°.

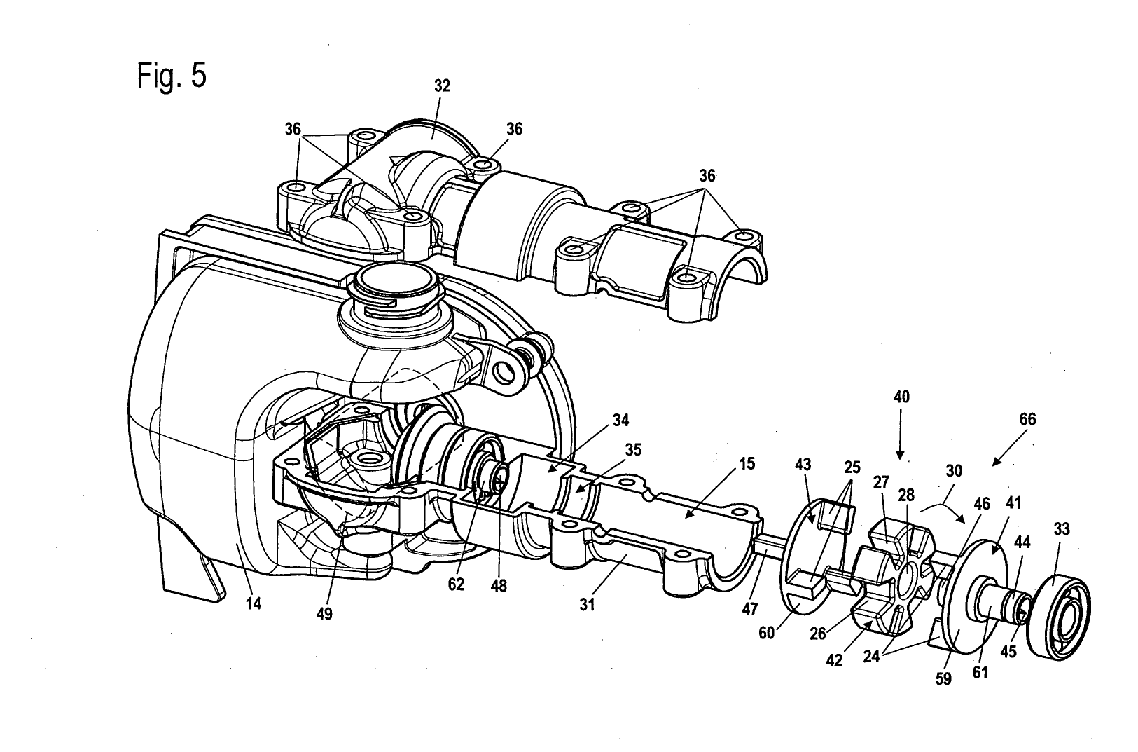

In the embodiment of FIGS. 4 and 5, a coupling device 66 is configured as a free-running unit 40 and is mounted between the drive shaft 8 and the gear assembly 49 shown schematically in FIG. 5. As FIG. 5 shows, the gear assembly housing 9 has two half shells 31 and 32 which are partitioned in the direction of the rotational axis of the drive shaft 8. The two housing half shells 31 and 32 form the receptacle 15. The housing half shells 31 and 32 have a plurality of bores 36 for screws with which the two housing half shells 31 and 32 can be connected to each other. In the region of the receptacle 15, the housing half shells 31 and 32 have a slight spacing to each other when they are connected together so that the guide tube 3 can be clamped at the receptacle 15 between the two housing half shells 31 and 32.

The gear assembly housing 9 has a receptacle 35 for a bearing 33 as well as a receptacle 34 for the free-running unit 40. The free-running unit 40 has a drive element 41, a coupling device 42 as well as an output element 43. The drive element 41 has a lug 61 which projects through the bearing 33 and a receptacle 44 for the drive shaft 8 is formed on the bearing 33. The receptacle 44 has a four-edge cornered profile 45 in its interior whereinto a four corner profile of the drive shaft 8 can be inserted. The lug 61 extends from a planar circularly-shaped base plate 59 of the drive element 41. A bearing support 46 is formed on the end of the drive element 41 which lies opposite to the lug 61. The bearing support 46 projects into a center bore 28 of the coupling element 42. Pawls 24 are formed on the base plate 59 in a direction toward the output element 43. The output element 43 has a base plate 60 on which three pawls 25 are formed which project in a direction toward the drive element 41. The coupling element 42 is configured identical to the coupling element 22 of the free-running unit 20. The pawls 24 and 25 of the free-running unit 40 also correspond to the pawls 24 and 25 of the free-running unit 20.

A four cornered support 47 is formed on the side of the base plate 60 of the output element 43 which faces away from the drive element 41. The four cornered support 47 projects into a four cornered receptacle 48 of a shaft 62. The shaft 62 is the input shaft of the gear assembly 49.

A section through,the free-running unit 40 is shown in FIG. 4. The coupling element 42 has slots 27 for the pawls 25. The width (b) of the pawls 25 is measured in the peripheral direction and corresponds to the width (b) of the slots 27. The pawls 24 have a width (a) measured in the peripheral direction. For the pawls 24, the coupling element 42 has slots 26 having a width (c) greater than the width (a) of the pawls 24. The width (c) is measured in the peripheral direction. A spacing of an angle (α) is formed between the pawls 24 and a stop 58 formed on the coupling element 42. The drive element 41 and the coupling element 42 can be rotated by the angle (α) about the rotational axis of the drive shaft 8. The free-running unit 40 effects a decoupling of the movement of the work tool from the drive shaft 8. In this way, vibrations of the work tool (that is, the saw chain 11), which are transmitted to the gear assembly 49, are not transmitted further to the drive shaft 8.

The coupling elements 22 and 42 can be made of solid material. Advantageously, the coupling elements 22 and 42 are, however, of a material which has a dampening and/or resilient characteristics. Advantageously, the coupling elements 22 and 42 are made of plastic. However, other coupling elements can be used such as springs or the like. When using one or several elastic coupling elements, it can be provided that the coupling element(s) lie against the drive element without spacing in the rotational direction or counterrotational direction. The relative movement of the output element relative to the drive element, in this case, is achieved because of the elasticity of the coupling element and not by overcoming a dead space. For the relative movement, the force is needed which is needed for the deformation of the coupling element(s).

An embodiment of a coupling device 67 wherein no dead space is provided between drive element 21 and output element 23 is shown in FIG. 6. The configuration of the coupling device 67 corresponds essentially to that of coupling device 65. The coupling device 67 has a drive element having pawls 24, an output element having pawls 25 and a coupling element 22. In each slot 26 of the coupling element 22, a spring element 68 is mounted on one side of the pawls 24 and a damping element 69 is mounted on the opposite-lying side.

When a torque is transmitted from the drive element having the pawls 24 to the output element having the pawls 25, then the pawls 24 move against the force of the springs 68 until the springs are completely compressed or the transmitted force is sufficient to drive the saw chain 11. With a transmission of a rotational movement in the opposite direction from the pawls 25 to the pawls 24, the pawls 25 and the coupling element 22 move in the rotational direction 30 relative to the pawls 24 until the damping elements 69 lie on the coupling element 22 against the pawls 24. This relative movement is supported by the spring elements 68. The force transmission takes place via the damping elements 69. The formation of natural vibrations can be avoided because of the different damping characteristics in the two operating directions.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
a motor housing;
a work tool;
a drive shaft;
connecting means for operatively connecting said work tool to said drive shaft;
a drive motor mounted in said housing for driving said work tool via said drive shaft and said connecting means; and,
said connecting means including a coupling device disposed between said drive shaft and said work tool for permitting a limited movement of said work tool relative to said drive shaft.

2. The portable handheld work apparatus of claim 1, further comprising:
a component for accommodating said work tool;
a guide tube for said drive shaft;
said guide tube having a first end attached to said motor housing and a second end attached to said component; and,
said drive shaft having a predetermined length and being accommodated in said guide tube over at least a portion of said predetermined length.

3. The portable handheld work apparatus of claim 2, wherein said component is a gear housing and said connecting means comprises a gear assembly mounted in said gear housing; and, said drive shaft is operatively connected to said work tool via said gear assembly.

4. The portable handheld work apparatus of claim 3, said connecting means further comprising a coupling device disposed between said drive shaft and said gear assembly.

5. The portable handheld work apparatus of claim 3, said connecting means further comprising a coupling device disposed between said gear assembly and said work tool.

6. The portable handheld work apparatus of claim 2, wherein said predetermined length of said guide tube is greater than 0.5 meter.

7. The portable handheld work apparatus of claim 1, further comprising a centrifugal clutch disposed between said drive shaft and said drive motor.

8. The portable handheld work apparatus of claim 1, said connecting means comprising a coupling device having a drive element operatively connected to said motor and an output element operatively connected to said work tool.

9. The portable handheld work apparatus of claim 8, said drive element having at least one drive pawl and said output element having at least one output pawl; and, said drive pawl and said output pawl conjointly defining an operative connection between said drive element and said output element.

10. The portable handheld work apparatus of claim 9, said coupling device further comprising a coupling element disposed in said operative connection between said drive element and said output element.

11. The portable handheld work apparatus of claim 10, wherein said coupling element is movable between said drive pawl and said output pawl by an angle (α).

12. The portable handheld work apparatus of claim 10, wherein said coupling element is configured to have damping and/or spring characteristics.

13. The portable handheld work apparatus of claim 8, said coupling device having a first set of spring and/or damping characteristics in the operating direction from said drive motor to said work tool and a second set of spring and/or damping characteristics in the operating direction from said work tool to said drive motor; and, said first set of spring and/or damping characteristics being different from said second set of spring and/or damping characteristics.

14. The portable handheld work apparatus of claim 8, wherein said coupling device is a free-running device.

15. The portable handheld work apparatus of claim 1, wherein said work tool is a saw chain and said work apparatus is an overhead branchcutter.

16. The portable handheld work apparatus of claim 1, wherein said drive motor is an internal combustion engine.
